(19) United States
(12) Patent Application Publication
(10) Pub. No.: US 2010/0031486 A1
(43) Pub. Date: Feb. 11, 2010

(54) Hose quick release tool

(76) Inventor: Bryan L. Catlin, Albion, NY (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/461,199

(22) Filed: Aug. 4, 2009

Related U.S. Application Data
(60) Provisional application No. 61/136,035, filed on Aug. 7, 2008.

(51) Int. Cl. B23P 19/04

(52) U.S. Cl. 29/237

(57) ABSTRACT

The hose quick release tool is a one-piece tool that is easily manipulated to engage a conduit at the coupling juncture and deform the coupling assembly in a manner to affect a release of the coupling assembly without incurring any damage to the assembly. The tool has multiple embodiments, each embodiment of the tool having openings that are dimensioned and configured to adapt to most conventional quick-coupling assemblies. The tools are preferably fabricated from metal for durability.

### CROSS-REFERENCE TO RELATED APPLICATION

This application claims the benefit of U.S. Provisional Patent Application Ser. No. 61/136,035, filed Aug. 7, 2008.

### BACKGROUND OF THE INVENTION

1. Field of the Invention

The present invention generally relates to decoupling devices, and particularly to a hose quick release tool for releasing quick connect assemblies for hoses or similar conduits.

2. Description of the Related Art

Quick connect coupling assemblies for conduits have become very popular in recent years and are employed in both commercial and home environments. Conventionally, the quick connect assemblies comprise two connecting members, viz., female and male. The female member is provided with an opening that is adapted to receive the male member for locking engagement therein. An elastically deformable member is mounted in the opening of the female member and functions to engage a recess in the male member to lock the male member against being separated from the female member. The coupling operation is very smooth and can be accomplished quickly with minimum effort and requires no tools.

Unfortunately, uncoupling requires more effort in that disengaging the elastic deformable member from the recess often requires amounts of manipulation and exertion that are time-consuming and somewhat frustrating. An adjunct that would simplify the decoupling procedure would surely be a welcomed addition in the art. Thus, a hose quick release tool solving the aforementioned problems is desired.

### SUMMARY OF THE INVENTION

The hose quick release tool comprises different embodiments of one-piece tools that are easily manipulated to engage a conduit at the coupling juncture and deform the coupling assembly in a manner to effect a release of the coupling assembly without incurring any damage to the assembly. The tools respectively have openings that are dimensioned and configured to adapt to most conventional quick-coupling assemblies. The tools are preferably fabricated from metal for durability. Other materials, e.g., plastic, can be employed, if suitable.

Accordingly, the instant invention presents a tool for effecting the release of quick-connect conduit couplings in a fast and efficient manner. The invention provides for an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a first embodiment of a hose quick release tool according to the present invention.

FIG. 2 is a front, perspective view of the hose quick release tool of FIG. 1.

FIG. 3 is a rear, perspective view of the hose quick release tool of FIG. 1.

FIG. 4 is a front, perspective view of a second embodiment of a hose quick release tool according to the present invention.

FIG. 5 is a rear, perspective view of the hose quick release tool of FIG. 4.

FIG. 6 is a front, perspective view of a third embodiment of a hose quick release tool according to the present invention.

FIG. 7 is a rear, perspective view of the hose quick release tool of FIG. 6.

Similar reference characters denote corresponding features consistently throughout the attached drawings.

### DETAILED DESCRIPTION OF THE PREFERRED EMBODIMENTS

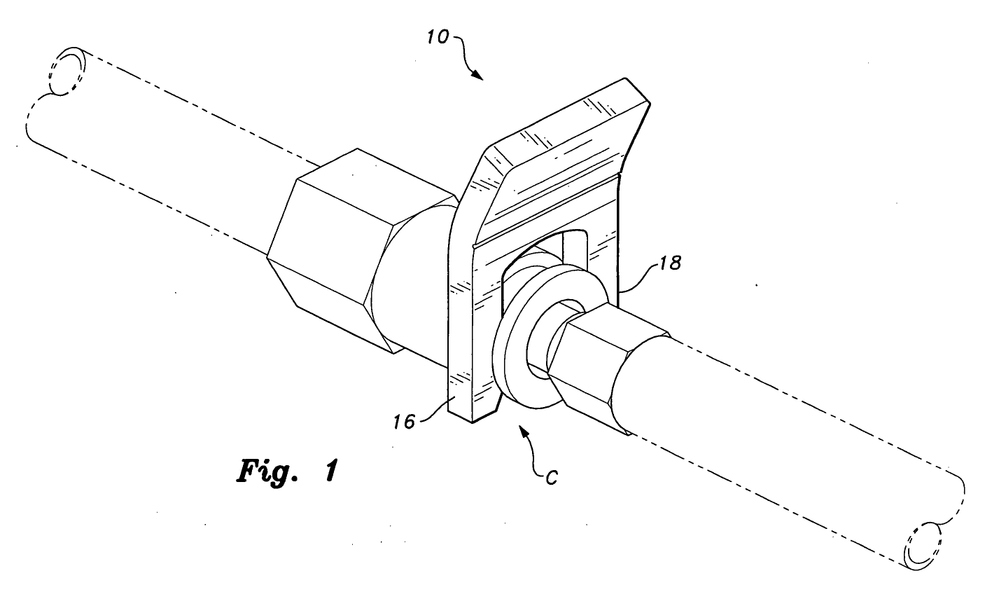

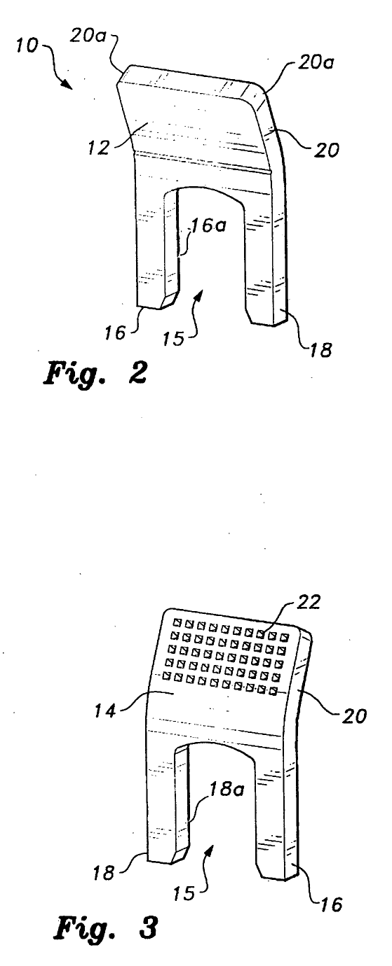

Attention is first directed to FIGS. 1-3, wherein a first embodiment of a hose quick release tool is generally indicated at 10. Tool 10 comprises a plate of rectangular configuration having a front face 12 and a rear face 14. A central opening 15 is formed in one end of the plate, forming a fork having prongs 16 and 18. The part of the plate adjoining the fork forms the handle 20. Handle 20 is bent approximately ten degrees toward the front face for reasons explained below. Handle 20 is provided with a roughened, textured, or knurled surface 22 on its rear face to enhance gripping. The top edges of handle 20 are provided with a slight curvature at 20a for comfort when manipulating the tool.

Opening 15 is sized to accommodate a conventional coupling assembly C. The inner edges 18a, 16a of prongs 16 and 18 are beveled in a manner to engage the deformable element of the coupling assembly C. The tool 10 will be manufactured in different sizes to accommodate the different sizes of conventional coupling assemblies. Bent handle 20 acts to increase leverage when the tool 10 is manipulated to decouple the assembly.

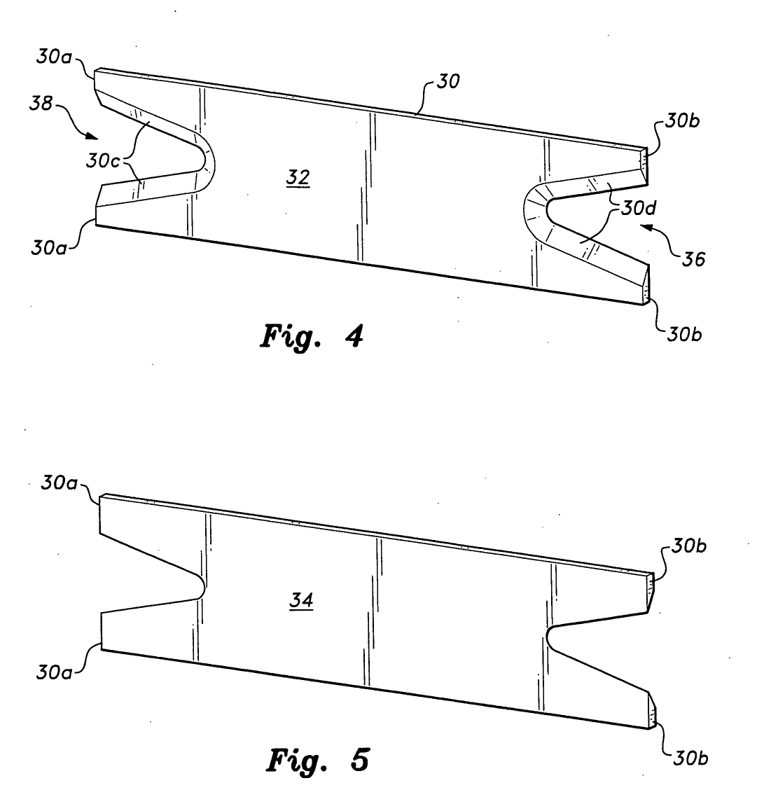

FIGS. 4 and 5 disclose a second embodiment of a hose quick release tool comprising a rectangular plate 30 having respective first and second ends, front face 32 and rear face 34. Respective triangular-shaped openings 36 and 38 are formed at each end, defining respective prongs 30a and 30b. The inner front surfaces of the respective prongs are beveled at 30c and 30d. Openings 36 and 38 are different in size, allowing the tool to be employed to decouple two different sizes of conventional coupling assemblies.

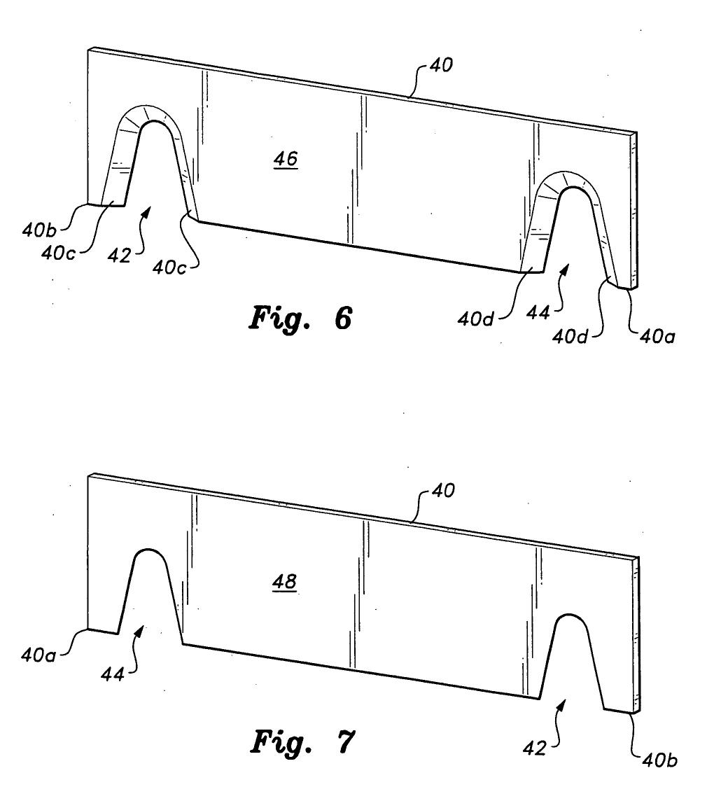

A third embodiment of a hose quick release tool is illustrated in FIGS. 6 and 7. Rectangular plate 40 has respective front and rear faces 46, 48. Respective triangular-shaped openings 42, 44 are formed in one side of the plate 40, creating respective end prongs 40a and 40b. One side of each triangular opening 42, 44 is defined by the plate surface. Respective bevels 40c, 40d are formed in the front faces of openings 42, 44. As in the embodiment described immediately above, openings 42, 44 are different in size, allowing the tool to be employed to decouple two different sizes of conventional coupling assemblies. A portion of the rear faces of the second and third embodiments can be provided with respective roughened, textured, or knurled surface areas to enhance gripping.

In use, a tool is selected that will accommodate the particular dimensions of the coupling assembly to be decoupled. The tool is positioned on the assembly to engage the deformable member and leveraged to deform the member and decouple the assembly.

It is to be understood that the present invention is not limited to the embodiments described above, but encompasses any and all embodiments within the scope of the following claims.

I claim:

1. A hose quick release tool, comprising a rectangular body member having at least one opening formed therein, the opening having a pair of inner edges, each of the inner edges being beveled.

2. The hose quick release tool according to claim 1, wherein the at least one opening comprises two openings formed in said rectangular body member.

3. The hose quick release tool according to claim 1, wherein said rectangular body member has a front face and a rear face, and includes a roughened surface formed on a portion of said rear face.

4. The hose quick release tool according to claim 1, wherein said rectangular body member forms a handle portion above and adjacent to the at least one opening, and wherein said handle portion is formed at an angle relative to the at least one opening.

5. The hose quick release tool according to claim 1, wherein said rectangular body member has a first end and a second end, the at least one opening comprising a first opening formed in the first end and a second opening formed in the second end.

6. The hose quick release tool according to claim 5, wherein the first and second openings are different in size.

7. The hose quick release tool according to claim 1, wherein said rectangular body member has a first side and a second side, the at least one opening comprising a first opening and a second opening formed in the first side.

8. The hose quick release tool according to claim 7, wherein the first and second openings are different in size.

9. The hose quick release tool according to claim 1, wherein said rectangular body member is made from metal.

10. The hose quick release tool according to claim 1, wherein said rectangular body member is made from plastic.

11. A hose quick release tool, comprising a rectangular body member having a front face, a rear face, a first end, a second end, a first side, a second side, and at least one opening formed therein, the at least one opening having a pair of beveled edges.

12. The hose quick release tool according to claim 11, further including a roughened surface formed on a portion of the rear face.

13. The hose quick release tool according to claim 11, wherein said rectangular body member forms a handle portion above and adjacent to the at least one opening, the handle portion being formed at an angle relative to the at least one opening.

14. The hose quick release tool according to claim 11, wherein the at least one opening comprises two openings formed in said body member, including a first opening formed in the first end and a second opening formed in the second end.

15. The hose quick release tool according to claim 14, wherein the first and second openings are different in size.

16. The hose quick release tool according to claim 11, wherein the at least one opening comprises two openings formed in said body member, both of the openings being formed in the first side of said body member.

17. The hose quick release tool according to claim 16, wherein the two openings are of different sizes.

18. The quick release tool according to claim 11, wherein said rectangular body member is made from metal.

19. The quick release tool according to claim 11, wherein said rectangular body member is made from plastic.
